(19) United States
(12) Patent Application Publication
(10) Pub. No.: US 2011/0195774 A1
(43) Pub. Date: Aug. 11, 2011

(54) Video game kiosk apparatus and method

(76) Inventor: Christopher Gerding, Wadsworth, OH (US)

(21) Appl. No.: 12/927,523

(22) Filed: Nov. 16, 2010

Related U.S. Application Data
(60) Provisional application No. 61/281,475, filed on Nov. 17, 2009.

(51) Int. Cl. G06F 17/00

(52) U.S. Cl. 463/29; 463/31

(57) ABSTRACT

A video game apparatus is provided. The video game apparatus includes an enclosure having a monitor and at least one speaker and a home video game located in the enclosure. A computer processor located within the enclosure and communicating with the home video game, the processor enabling a charge-by-time play of the home video game. A remote management apparatus, located remotely from, and communicating with the computer processor, the remote management apparatus enabling operation of the video game apparatus for a specified time period.

Priority is claimed to provisional application Ser. No. 61/281,475, filed Nov. 17, 2009, entitled Video Game Kiosk Apparatus and Method, which is referred to and incorporated herein in its entirety by this reference.

### FIELD OF THE INVENTION

The present invention generally relates to a video game system, which allows multiple home video game systems to be adapted to an arcade style game.

### BACKGROUND OF THE INVENTION

In the video game industry, home video game systems have become more and more popular since their inception, due to increased graphical capabilities, low price, and the availability of a large selection of games. This is contrasted to the arcade style video game units, which provide only one dedicated game per cabinet. Purchasing an arcade game for the home environment therefore becomes impractical. On the other hand, home game systems also tend to create clutter around the home television the system is connected to, with games and controllers typically left out after play.

At the same time, arcade style video games offer a number of attractive features, such as arcade style controllers and joysticks, which are not found in a home game system. The arcade games also may have a stereo system for enhancing the sound of the game. Other possible unique features may include a vibrating seat or the like, and an angled screen, which allows players to remain close to the game. All of these features enhance the experience of playing the video game.

Although the home video game units allow for a broader range of video games to be played by the unit, it would desirable to have arcade style features, and the ability to consolidate and hide the games, game system and controllers, when not in use. It would also be worthwhile to provide a system, which allows multiple game systems to be used with an independent set of controllers, preferably using arcade style controls. Therefore, it would be desirable to provide a video game adapter system that allows home video game systems to be converted to include arcade style video game features.

Therefore, there remains a need to overcome one or more of the limitations in the above-described, existing art. The discussion of the background to the invention included herein is included to explain the context of the invention. This is not to be taken as an admission that any of the material referred to was published, known or part of the common general knowledge as at the priority date of the claims.

These and other features and advantages of the present invention will be appreciated from review of the following Detailed Description of the Preferred Embodiments, along with the accompanying figures in which like reference numerals are used to describe the same, similar or corresponding parts in the several views of the drawings.

### BRIEF DESCRIPTION OF THE DRAWINGS

FIG. 1 is a front view of a video game kiosk according to an embodiment of the present invention;

FIG. 2 is a perspective view of the video game kiosk of FIG. 1 with a movement detecting system;

FIG. 3a-b is a plan view of two slideable game controllers in different positions;

FIG. 4 is a perspective view of another embodiment of the video game kiosk;

FIG. 5 is a perspective view of the video game kiosk of FIG. 4 with a movement detecting system;

FIG. 6 is a chart showing operations and functions of the video game kiosk; and

FIG. 7 is a chart showing additional operations and functions the video game kiosk.

It will be recognized that some or all of the Figures are schematic representations for purposes of illustration and do not necessarily depict the actual relative sizes or locations of the elements shown. The Figures are provided for the purpose of illustrating one or more embodiments of the invention with the explicit understanding that they will not be used to limit the scope or the meaning of the claims.

### DETAILED DESCRIPTION OF THE PREFERRED EMBODIMENTS

In the following description, for the purposes of explanation, numerous specific details are set forth in order to provide a thorough understanding of a video game kiosk (hereinafter VGK) of the present invention. Throughout this description, the embodiments and examples shown should be considered as exemplars, rather than as limitations on the VGK. That is, the following description provides examples, and the accompanying drawings show various examples for the purposes of illustration. However, these examples should not be construed in a limiting sense as they are merely intended to provide examples of the VGK rather than to provide an exhaustive list of all possible implementations of the VGK.

Home video game systems and games have far outpaced the graphics and game play available at today's public arcade venues. It has long been the desire of manufactures in the coin-operated arcade industry to remain competitive by marrying the home games and game console with public use arcades, by using these games and systems in a pay-to-use and unmonitored environment. Several attempts have been made to use a home video game system and games in a pay-by-time application. Paying for time to play a game is a simple way to convert a home game to a profit generating application, as no modification to the home game software is required. Traditional public use arcade games are skill based, meaning that money is inserted and play time will vary based on the proficiency of the player. Time-based or pay-to-use gaming does not require such skill, as it is in fact only renting time for the player to use the equipment. When time period purchased has expired the game will end, typically resulting in the reset of the game system and shutting down of power to the game console control devices (such as handheld controls or arcade joysticks). Prior to the VGK, such efforts have been ineffective in reaching broad market acceptance for a number of key reasons.

Most importantly, the EULA (end user license agreement) for games sold to the public clearly restricts the use to home and private environments. Unauthorized public use of such software is also strictly protected by federal and international copyright laws. Steep penalties for violation of these laws have prevented mass acceptance and application of the concept to the world market.

Secondly, game system hardware, such as the Xbox 360 and Playstation 3, includes adjustability that can be made to the game system. For example, if a player, or other person, has access to the root menu of the game system, the player is granted access to certain options such as video resolution settings. If a player adjusts these settings the performance and experience of game play will alter. Changing such settings makes it impossible to provide a consistent player experience in a public application. In fact, access to this root menu (also known as “dashboard”) can even allow the player, or other person to power the game console off. If this is done in a public environment the game will appear to be off or broken, and earnings will be negatively affected, therefore making the use of a home video game console in a public environment difficult to control without close supervision.

Thirdly, home video game systems are not designed for constant use, such as in a public application where the power may be on for 24 hours a day, 7 days a week. Most home game consoles will fail if left on for extended periods of time. The limitation of a home game console to withstand constant use is a barrier to a building a successful commercial product, as the expense of frequent replacement of game hardware diminishes the profitability of the overall system.

Finally, most home video game consoles feature a technical barrier to successful coin-operated kiosk integration related to the powering on and resetting of the game console. Current generation home video game console power cannot be controlled by means of simply switching the power source connected to the game console. A secondary event is required to trigger the game console to boot-up, such as the physical pressing of the power button on the game console. A home video game console in a commercial kiosk should not allow the general public direct physical access to the game console, in the interest of preventing theft and damage. Prior to the VGK, methods used to resolve the power control issue involve the opening of a game console case and making internal modifications to the game console which void the warranty of the game console and complicates the commercial execution of the product concept. One aspect of the VGK is to manage the turning on and resetting of the installed home video game console.

In addition, the nature of a home video game console controller device when used with a game is such that when the control device is disconnected from the game console during an active game, the game being played will pause and inform the player to reconnect the game controller to continue play, which will make the game kiosk appear to be malfunctioning at the time. This is an inherent problem with disconnecting a control device from a game console in a game kiosk application while a game is in progress. One aspect of the VGK resolves this issue with a final countdown, a reset, power control, and video switching capability.

The VGK improves the concept of public home game console/games using pay-by-time and makes it successful in the marketplace by addressing the major issues listed above. The invention has many other features claimed below that make the invention novel in its execution.

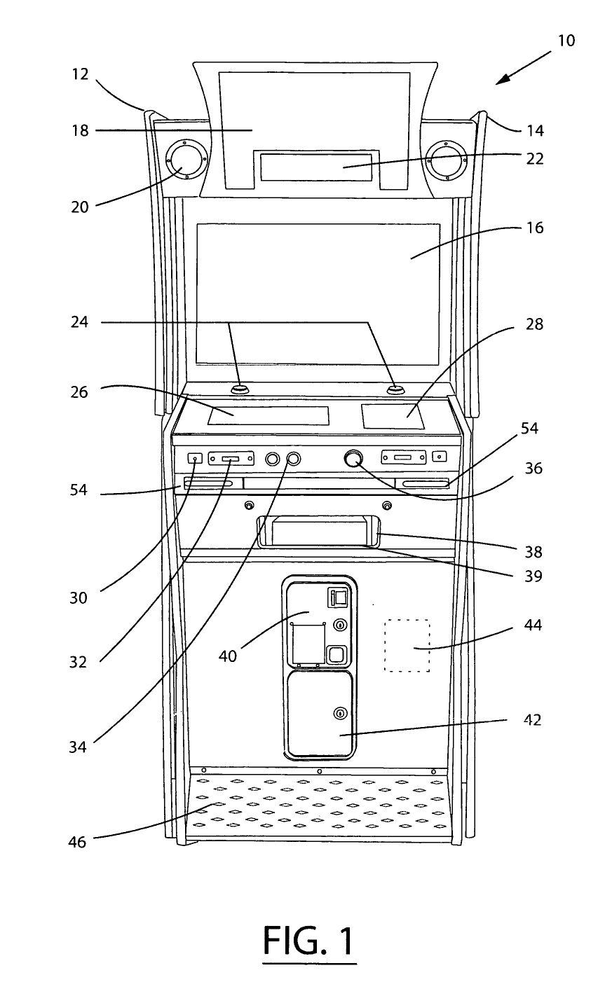

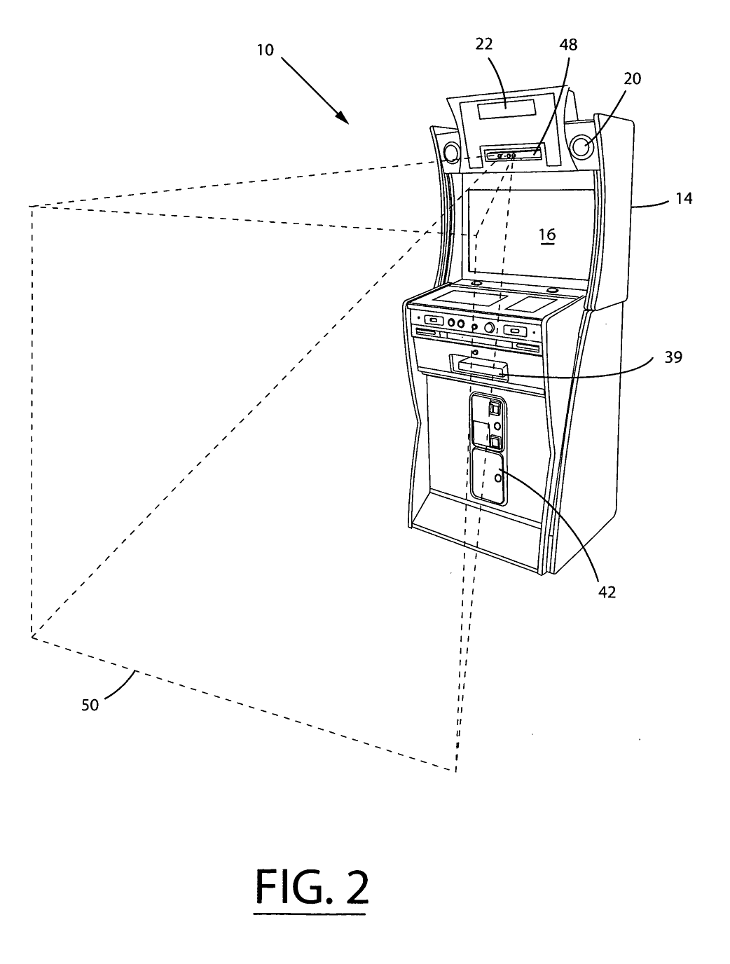

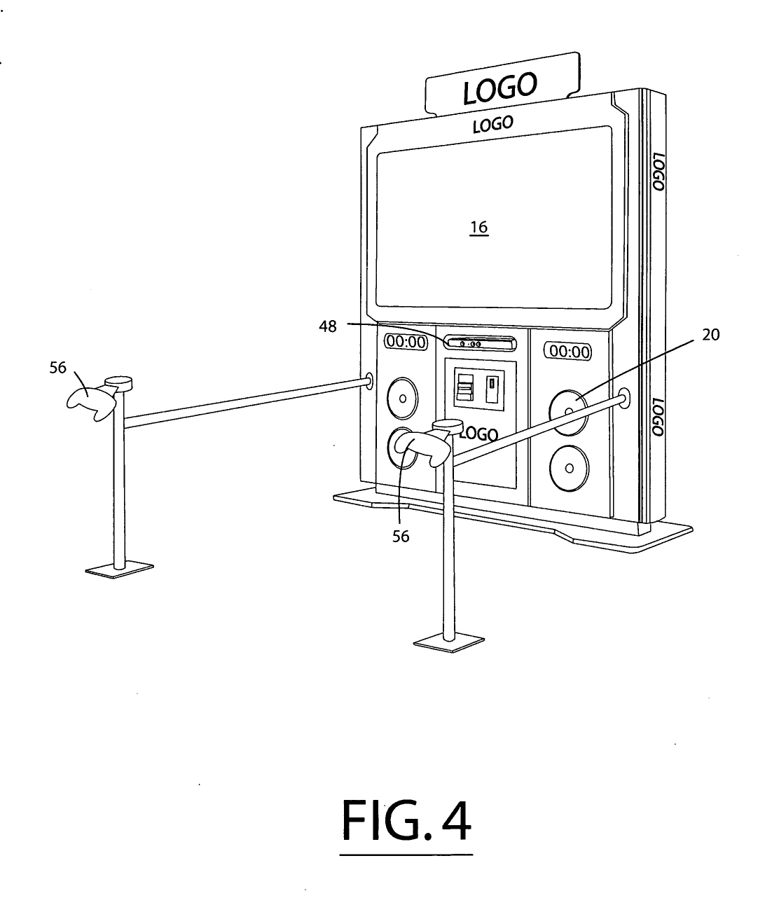

Referring now to FIGS. 1 and 2, a video game kiosk (hereinafter VGK) 10 of the present invention is illustrated. The VGK 10 may be of any suitable configuration, and is shown in this embodiment, as an arcade style video game cabinet, but may also be configured as shown in FIG. 4, which comprises a flat-panel display unit. The cabinet embodiment, illustrated in FIGS. 1-2, includes two sides 12 and 14 that may include lighting effects, such as LEDs, a front and a top and back (not shown) in a normal fashion. The front of the cabinet includes a monitor 16, and above the monitor 16 is a backlight marquee 18 that can contain any desired message, text and graphics. Two speakers 20 are located above the monitor 16, as well as a display board 22 that can display scrolling text.

Below the monitor 16 are illuminated player start buttons 24, a backlit game instruction panel 26 and a game case holder 28 that displays the home video game that is currently installed.

Headphone input jacks 30 are located on both sides of the cabinet, with memory ports 32 adjacent for receiving Xbox 360 profiles. Headphone volume control 34 is provided, and a reset button 36 can reset a displayed game.

A home video game compartment 38 includes a lockable transparent door to display the type of home video game 39 installed in the cabinet, such as a Microsoft XBOX, a Sony Playstation, a PC-based computer system, an Apple computer system, or other home video game system.

Below the lockable door 38 is a coin receiver 40 and a covered compartment containing a user interface panel 42 that includes USB service ports connected to a computer 44 located in the cabinet (discussed below). The user interface panel 42 may also include an RJ45 or Ethernet jack as well as stereo and video output jacks that also communicate with the computer 44.

The computer 44 includes a main unit housing a data processor, semiconductor memory, and bulk storage memory, together with various interfaces enabling the computer to communicate with anything on the VGK 10, including the home video game 39 and any of following, as required: the home video game 39, monitor 16, marquee 18, speakers 20, display board 22, player buttons 24, headphone jacks 30, memory ports 32, headphone volume 34, reset button 36, coin receiver 40, and a remotely located server 58 via a suitable communications network which may be a LAN, a WAN, a dial up connection or any other suitable communication scheme. The memory includes executable code for performing the functions described herein.

At the base of the cabinet is a tread plate 46 that is preferably constructed of aluminum. Another embodiment VGK 10 may be a standalone unit or be configured to be supported on a tabletop or other surface (not shown). This unit arranges the above-described elements in a compact shape to fit on a tabletop.

The VGK 10 embodiment illustrated in FIG. 2 also includes a three dimensional sensor and camera system 48 that senses movement within the dashed sensor area 50. The three dimensional sensor and camera system 48 includes a depth camera, a color motion camera, at least one microphone and associated software. For example, the three dimensional sensor and camera system 48 may be manufactured by Microsoft and marketed as Kinect.

The three dimensional sensor and camera system 48 uses the player's physical body as the method to control the home video game 39, where actions such as jumping, running, kicking, throwing, dancing, in place and/or voice commands will be detected by the home video game 39 and be used to operate the home video game 39. The three dimensional sensor and camera system 48 is connected to the home video game 39 through a data port, such as USB. One embodiment of the VGK 10 may use the three dimensional sensor and camera system 48 in a commercial pay-to-use environment.

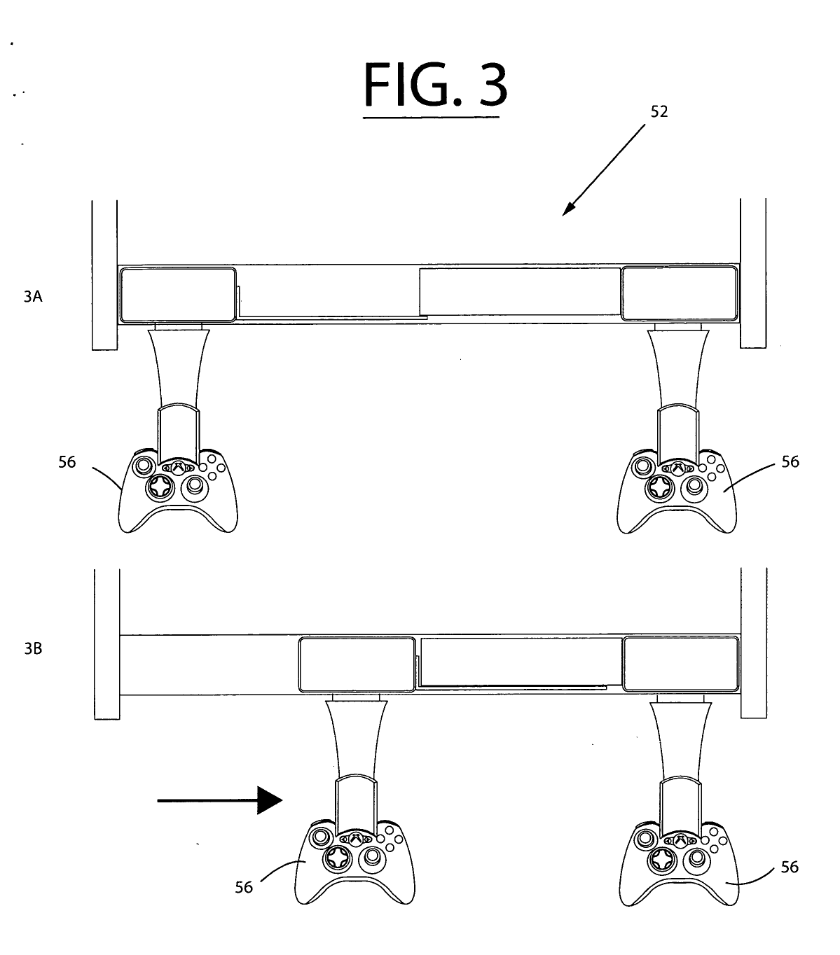

Referring now to FIG. 3a-b, a slideable game controller system 52 is illustrated. As shown in FIG. 2, the VGK 10 includes game controller slots 54 that are sized to receive game controllers 56. The game controllers 56 are preferably controllers used for home based video games, such as Xbox360 Micron control pads or Playstation Dual Shock units. The game controller slots 54 allow the game controllers 56 to slide across the front of the VGK 10 cabinet, as shown in FIG. 3b. This allows a single player to center one game controller 56 when playing alone, or move the game controllers 56 apart from each other for play with two players, as shown in FIG. 3a.

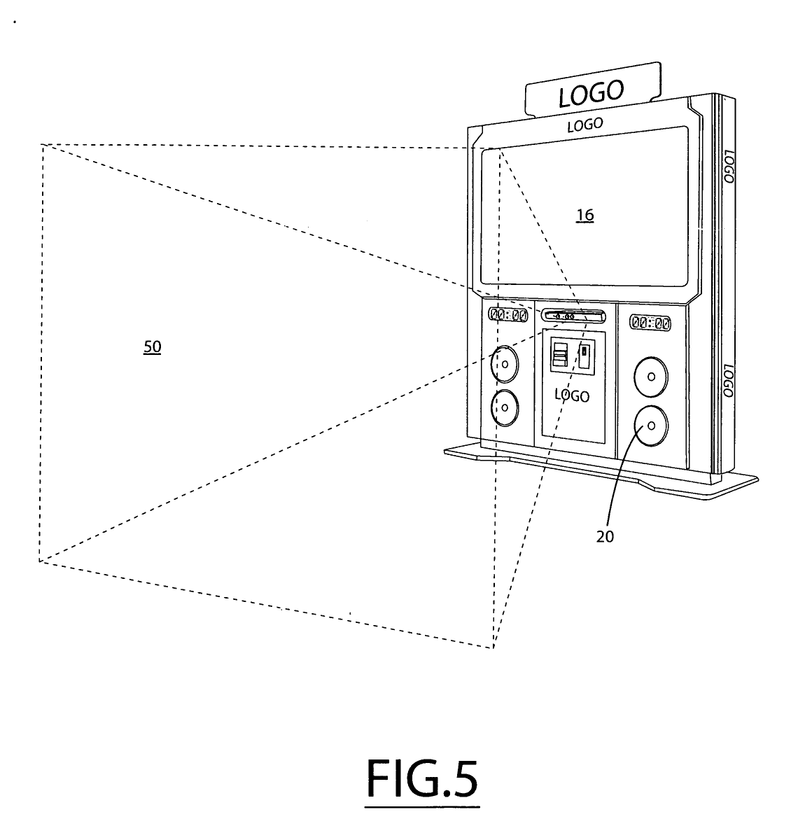

As shown in FIGS. 4 and 5, a flat-panel VGK 10 is illustrated. The flat-panel VGK 10 includes a monitor 16 that is larger than the monitor in the cabinet VGK 10 shown in FIGS. 1 and 2, but the flat-panel VGK 10 includes the same elements, as required, as the cabinet VGK 10, and provides the same functionality as the cabinet VGK 10 described above.

As discussed above, one problem associated with the public use of a home based video game system is the EULA (end user license agreement). The EULA limits home based video games exclusively to private use. However, one feature of the VGK 10 is the ability to provide a method to publicly play home based video games. Generally this is provided by granting a temporary license to the private video game system, the temporary license enabling play of the private video game system in a public environment. The status of each VGK 10 in public use can be remotely monitored to ensure compliance with the temporary license.

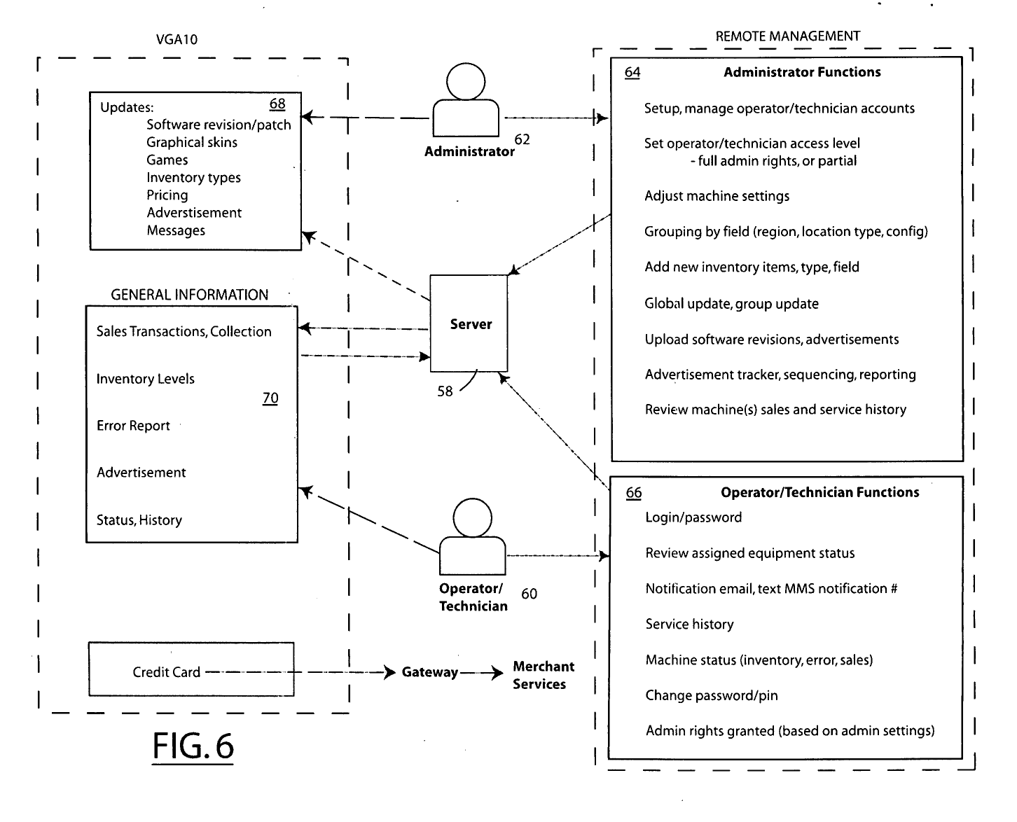

Referring now to FIG. 6, one method of employing a VGK 10 in a public environment is illustrated. A remote server 58 is comprised of one or more computer processors and associated memory, and also includes various interfaces enabling the remote server 58 to communicate with the VGK 10 as well as an operator/technician 60 and administrator 62. The administrator 62 can perform the administrator functions 64, and the operator/technician 60 can perform the operator/technician functions 66. The administrator 62 and the operator/technician 60 can access the VGK 10 through the remote server 58 that communicates with the computer 44 located within the VGK 10 cabinet. The administrator 62 and the operator/technician 60 can perform update functions 68 and obtain general information 70.

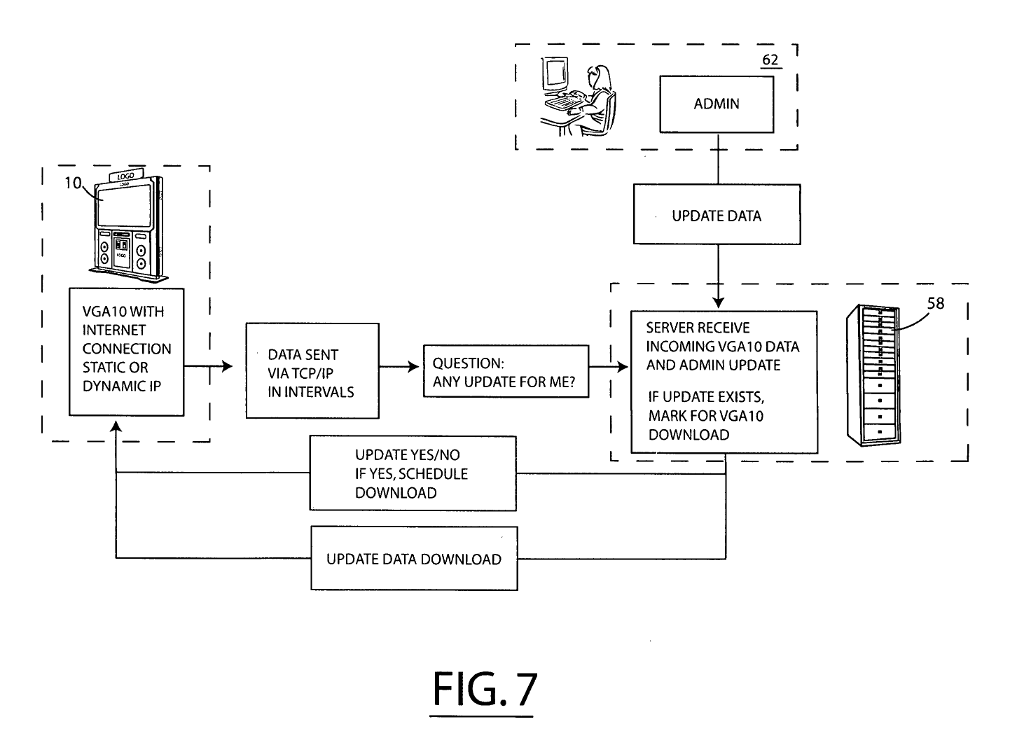

Shown in FIG. 7 is a one method of remotely communicating with the VGK 10. The administrator 62 transmits data to the remote server 58 which communicates with the VGK 10. The VGK 10 can also query the remote server 58 for updates.

The communication between the administrator 62, the operator/technician 60, the remote server 58 and the VGK 10 can include many different functions, processes and procedures. Below is a list of some of these capabilities.

### Enforcement Model for Public Time-Based Use of a Home Based Video Game

This method makes a public-use, for profit time-based pay-to-use VGK 10 housing a home video game console legal and approved to operate in public venues. Various video game hardware manufactures and/or software publishers (hereafter “licensors”) and/or brokers (hereafter “license managers”) with required authority have licenses and sublicenses to authorize individuals and/or organizations (hereafter “licensees”) to use the home video game console software and/or hardware in a manner for profit and public use. The agreements set forth between the parties eliminate the pertinent EULA limitations, and the present system includes an integrated electronic method of renewal. Failure to maintain good standing with agreement terms such as lack of payment to specified parties or abusing granted rights by the licensee, may at the licensor and/or license managers discretion result in the licensee's inability to obtain specific data required to keep the VGK 10 fully operational.

One aspect of the VGK 10 is that the risk and responsibility is passed to the licensee with a self-expiring and electronically managed system that significantly improves agreement compliance, and is a necessary model to reduce infringement and maintain a positive working relationship between the licensing parties.

The VGK 10 includes a date-based expiration and renewal system to enforce terms of an agreement between parties by enabling/disabling key features of a video game kiosk as specified above. A unique, date embedded, serialized request code is generated by the VGK 10, and the system that will use the serialized request code to output a corresponding unique, date embedded response code through a flexible algorithm, which will activate the VGK 10 for a set period of days, months, or years.

One method in which the activation request code can be uploaded and converted to an activation response code is accomplished by a server/computer via network connection, or the response code can be manually read out loud over the phone or other means of communication by a qualified technician or license manager, so that the response code may be electronically or manually entered into the VGK 10 to establish the operable time period and termination date (hereafter “renewal date”). When the VGK 10 approaches the renewal date, a new request code must be generated by the VGK 10 to extend the operable period. The license manager and licensee can issue or sell an extension to this period of time by allowing the system to generate the activation response code, which will take the operable period to the next date requiring renewal. The next renewal date is set to a maximum date based on the terms of the agreement between the parties.

### Multiple VGK 10 Unit Expiration and Synchronization Methods

Another aspect of the VGK 10 is a method in which a licensee owning multiple VGK 10 units will synchronize the date of expiration in the case where the activation response codes have been entered on different days, with the purpose to simplify the tracking and management of the expiration date of the equipment and to keep the frequency of the activation system to a minimum.

This is accomplished by a system that enables the licensor or license manager to invoice the licensee for future days of use (hereafter “day credits”), and the method in which the day credit system calculates the days remaining to reach the next renewal period for all owned game kiosks, and the licensee applies the day credits towards the activation cycle to receive the necessary activation response code to extend the operable date to the next renewal period for all equipment that a licensee owns.

For example, each VGK 10 contains a home video game 39, and a computer 44. The computer 44 contains an integrated circuit with a unique identification number (UID) that is hashed by algorithm with the current date and time to generate a request code. This means that the request code contains information about the current date and the specific identification of the VGK 10. The licensee uses the VGK 10 to load a request code onto a USB stick, which can also be read as a number displayed on the display, or can be downloaded through an internet connection. The licensee logs onto the remote server 58 that downloads the activation request code and compares it to the desired synchronized future renewal date. Using a secure and changing algorithm, the remote server 58 will validate the information and output an activation response code, within which contains a day count for continued operation. The licensee loads this information into the VGK 10, by manual entry via keyboard or by internet connection, which decodes and interprets the data as a number of days to extend the period of operation.

### Applying Region Specific Restrictions

The above licensing system can limit product use based on the location of the VGK 10 in an effort to protect territories for distribution and honor any territory limitations that may exist with the licensor. Location data is collected during the activation process, which is filled in by the licensee for each VGK 10, and by collecting internet protocol (IP) location information received from the licensee during the activation upload process. Data is also collected when the computer 44 in the game kiosk is connected to the internet, and the computer 44 connects to the remote server 58 to give this information. The location data collected is compared to the serial number of the VGK 10, which is correlated with a distributor's specific country or territory, which may also be correlated with a specific agreement between licensee and licensor. If conflicts in territory are found, the licensor and license manager will be notified and have the ability to shut down the VGK 10 remotely if the computer 44 inside the VGK 10 is still connected to the internet, and/or flag the equipment in the remote server 58 to not allow the licensee to receive a response code required to extend the operable period to the next renewal date.

### Restriction of System Settings in a Non-Game State

Another aspect of the VGK 10 is a method to limit access to non-game specific settings that could otherwise negatively impact the profit generated by the overall system in an unsupervised public venue.

For example, Xbox 360's dashboard grants access to out of game settings. When a player is playing a game (meaning they are not in the dashboard), they can “drop” back to the dashboard to access the basic system settings (these are not the settings for the game, they are the settings for the game console itself, game specific settings can be adjusted while in the game setup menu, which is different). There are three ways that a player can drop to the dashboard in the Xbox 360. One is to press the Xbox “Guide” button, and follow the onscreen prompts to drop to dashboard. The other is to eject the game disc by pressing the eject button on the front of the system. The third is to have an Xbox 360 or Xbox 360 compatible infrared remote and press the guide button on the IR remote.

To prevent access to the dashboard, the VGK 10 addresses the above problems by several methods. One is to glue the Xbox Guide button in the controller, or somehow de-solder the microswitch inside the game controller. In the case of arcade controls, the VGK 10 omits the guide button from the control panel. To address the eject issue, the home video game 39 is housed where no one can press the eject button, which is accomplished by placing the home video game 39 inside a locking cabinet. The last method is to put black tape over the infrared port of the home video game 39. All of those methods are effective, but not optimal. Another method to communicate directly with the Xbox 360 and force a mode that rejects the guide button and IR transmissions, also known as “kiosk mode”. This is a software function. The VGK 10 communicates directly with the Xbox 360 to force the Xbox 360 into kiosk mode for the application of charge-for-play out of home use.

### Controlling the Power On and Reset of the Home Video Game in a Coin-Operated Kiosk

Another aspect of the VGK 10 is a method to turn the power on and off and/or the resetting of the home video game 39 that is alternative to switching the AC or DC power supplying the home video game 39, or by any means to physically tamper with the normal internal operations of the home video game 39.

Several embodiments are envisioned, including the use of infrared, RF such as Bluetooth to power the system, the signal of which contains a home video game 39 specific code to control the power state of the home video game 39, an event which is triggered by the electronics dedicated to managing time and player count in the VGK 10. Another method is through a console specific electrical signal passed through any signal input on the home video game 39 that notifies the home video game 39 that the power state should change. Another embodiment is the use of a solenoid or tens pad device to electrically and physical press the power switch on a home video game 39, the use of which is also triggered by the computer 44 at specified intervals and in response to input from the user.

### Video Switching and Power State Control

Another aspect of the VGK 10 is a method to reduce the time that a home video game 39 will be powered on in a public venue by controlling the power of the home video game 39 so that the home video game 39 has power only when specified by the computer 44, such as when the game is being played or intermittently to attract players to use the VGK 10. One method is that when the power of the home video game 39 is off an alternative video and audio source will display on the monitor 16 and speakers 20 so that the VGK 10 does not appear to be off and will continue to attract players in the reduced power state to extend the overall life of the home video game 39.

The VGK 10 includes the computer 44. The computer 44 has video output. The computer 44 has two video inputs and two video outputs. One input is coming from the home video game 39, the other is coming from the computer 44. The computer 44 switches the video almost instantly as needed. So, when the VGK 10 is idle and no-one is playing, the computer 44 runs videos and adverts and tries to attract a player. This is the “attract mode”, and in this mode the home video game 39 can be powered off because it is not being used. When the player inserts money, the computer 44 receives a pulse from the coin acceptor that money has been inserted. The video playing stops and the “insert credit screen” appears. Now, the player must chose 1 or 2 player game by pressing the corresponding button, which will switch the video to the home video game 39 input and power on the system. It should be noted that simply applying power to the home video game 39 does not turn it on. You have to communicate a power on request through the video port in order to do this. For the Playstation 3 the VGK employs a Tens electrode pad to press the power button, but alternate embodiments may employ a proprietary HDMI interface protocol.

Another aspect of the VGK 10 is a method that when the home video game 39 power and/or audio and video is off that alternative videos will be displayed to attract players and also run business advertisements. These are stored on the computer 44 hard drive and played through a media player. VGK 10 software can tell the mode and state of the machine, and if the equipment is in attract mode, it will play video files at random from a predetermined folder. In another embodiment, a sequencer for the videos is employed, so that licensees can offer more than just random intervals and can actually show advert customers the frequency of their particular ad use. Ads can be loaded through the USB port on the computer 44, and can also be managed through the remote server 58, meaning they can be uploaded and downloaded to the VGK 10 without physically being in front of the VGK 10.

### Video Switching and Power State of the Home Video Game

Another aspect of the VGK 10 is a method that when money is inserted into the VGK 10, where the home video game 39 is on but the game controllers 56 are currently deactivated, that the video and audio will switch to an alternate source, such as the computer 44 or video player device, and informs the player how to start and play the game currently installed in the home video game 39. An onboard audio/video selection relay chip is triggered by the computer 44 logic to switch the sources upon a signal received from the payment device. The computer 44 instructs the player to choose the number of players to begin the game. Once the player count is selected, the computer 44 will trigger the selection relay chip to switch back to the home video game 39 audio and video source. The game controllers 56 will activate based on the number of players selected and the game will be playable.

An alternative method is where the home video game 39 is in the power off state at the beginning of the cycle, where various videos are being displayed to attract and inform the player, that when monies are inserted that an image or video will appear to inform the player how to start and play the game currently installed in the home video game 39, and requests the player to select the number of players desired. The computer 44 is connected to a method for the player to choose the number of players to begin the game. Once the player count is selected, the computer 44 will trigger the selection relay chip to switch to the home video game 39 source, and the home video game 39 will power on if not already in the on power state. The game controllers 56 connected to the home video game 39 will activate based on the number of players selected and the game will be playable.

### Flexible Charge Rate for Multiple Players

Another aspect of the VGK 10 is a method in which the amount of time granted for money inserted will vary depending on whether there are one, two or more players playing a game, in such a case where the VGK 10 can be set to grant less time for per x dollar for a two player game as a one player game, thereby making the device more profitable if more than one player is using the equipment.

In traditional arcade machines, 1 player and 2 player games charge independent fees per player, the length of game play for each will vary depending on the skill level of the player. For example, if a game is one quarter to play, and a 1^{st} player inserts a quarter and begins play, the second player would have to insert another quarter to join the first player; the transaction is separate because the players are not actually sharing the cost of playing the game. In other words, if player 2's game ends, player 1 can continue, and it is up to player 2 to insert more money if he/she desires to reenter the game. Player 2 cannot enter the game by deducting credits from player 1 because the transaction for Player 1 has already been completed.

However, the VGK 10, which is based on time played, the cost of playing a game where more than one player is involved is shared by the total number of players. It is therefore unique in that a single payment device on the VGK 10 can be set to offer different time per coin rates (time/coin) based on the number of players. For example, if a player inserts a quarter and selects a one player game, the VGK 10 will grant ten minutes of play. If a two player game is selected the VGK 10 may only grant five minutes of play, based on the predetermined rate set by the owner of the VGK 10.

### Adding a Player to a Game in Progress

Another aspect of the VGK 10 is a method in which a game that is already in progress as a one player game can allow the VGK 10 to add a second or more players to the existing game, which will reduce the amount of time remaining for the game to be played for the first player, but allow the second player to join. For example, if the first player has inserted money and selected a one player game in the beginning of the cycle, and twenty minutes of play has been granted to the player, the game controller 56 is active, but the second player game controller 56 is inoperable, and five minutes into the first player's game experience, a second player wishes to be added, that either player can press a button on the VGK 10 which will disconnect the first player game controller 56 so that the game will temporarily pause, the video source will switch and a message will be displayed informing the player that the amount of time remaining in the cycle will be reduced by adding a second player, and the players must confirm or deny the action by pressing buttons or other means, upon confirmation of which the first player and second player will be reactivated, and the video and audio source will switch back to the home video game 39, and the second game controller 56 will allow the second player to use the game at the same time as the first player, and the time remaining to operate the equipment will be reduced by the specified amount or percentage. This method therefore charges the higher rate (time/coin) for a two player game even though a one-player game was selected in the beginning of the cycle.

Adding a Player with Power State

Another aspect of the VGK 10 is similar to the above description, with the exception that some games do not allow for the addition of a second player to enter a game in the middle of a one-player game cycle, which is dependent on the particular game being played. It is therefore a setting in the system that can be switched to a mode where such a game software that has the restriction of not allowing a second player to be added mid-cycle, that upon pressing the button confirms the addition of a second player to the game, that the VGK 10 will inform the players that time will be reduced, but also that the home video game 39 powering the game in progress must be reset to the starting position to allow the second player to join the game. Upon confirmation of adding the second player in this scenario, the computer 44 will trigger a power reset cycle to the home video game 39 and activate the first and second player game controllers 56 so that a two player game can be played from the game beginning, at the two player time/coin rate.

Removing a Player with Power State

Another aspect of the VGK 10 is a method in which a game that is already in progress with two or more players may remove a player from the existing game, which will increase the amount of game time for the remaining player(s). If, for example, the VGK 10 is set to grant ten minutes per quarter for a one player game, and five minutes of play for a two player game, and a two player game is in progress and twenty minutes of game time remain, that if a second player is removed from the game in progress that the time remaining will revert to the one-player rate, thereby increasing the time available in the example to forty minutes. The VGK 10 resolves this frozen state by resetting the game in progress and activating the game controllers 56 for the remaining players only.

Players are removed similar to the method that they are added to a game in progress taught above, where the game in progress will be paused by disconnecting all game controllers 56, and requesting confirmation to remove certain players, upon confirmation of which the VGK 10 will act according to instruction, and time remaining will be affected according to the algorithms set to the time/coin rate for the remaining number or players and based on the operable time remaining in the current cycle.

### Final Countdown, Video Switch and Power State

Another aspect of the VGK 10 is a method where the time count-down reaches zero, and the game controllers 56 disconnect, which will pause the game being played. The video and audio display will switch to an alternate video source with a final countdown, upon which the adding of funds into the VGK 10 will reconnect the game controllers 56 and video will switch to the home video game 39 so that play can continue, or the failure to add more funds in the final countdown period will result in the home video game 39 to shutdown or reset, which will terminate the game in progress and prevent further use until funds are added to initiate a new game.

As will be appreciated by one of skill in the art, embodiments of the VGK 10 may take the form of an entirely different hardware embodiment, an entirely different software embodiment or an embodiment combining software and hardware aspects.

The VGK 10 has been described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, embedded processor or other programmable data processing apparatus to produce a machine, such that the instructions, which execute via the processor of the computer or other programmable data processing apparatus, create means for implementing the functions specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flowchart and/or block diagram block or blocks.

Thus, it is seen that video game kiosk apparatus and method is provided. One skilled in the art will appreciate that the present invention can be practiced by other than the above-described embodiments, which are presented in this description for purposes of illustration and not of limitation. The specification and drawings are not intended to limit the exclusionary scope of this patent document. It is noted that various equivalents for the particular embodiments discussed in this description may practice the invention as well. That is, while the present invention has been described in conjunction with specific embodiments, it is evident that many alternatives, modifications, permutations and variations will become apparent to those of ordinary skill in the art.

1. A video game apparatus, comprising:
an enclosure comprising a monitor and at least one speaker;
a home video game located in the enclosure;
a computer processor located within the enclosure and communicating with the home video game, the processor enabling a charge-by-time play of the home video game; and
a remote management apparatus, located remotely from, and communicating with the computer processor, the remote management apparatus enabling operation of the video game apparatus for a specified time period.

2. The video game apparatus of claim 1, where the charge-by-time play establishes a specific time period for a player to play the home video game.

3. The video game apparatus of claim 1, where the remote management apparatus enables operation of the video game apparatus by obtaining a license having a specific duration.

4. The video game apparatus of claim 3, where the license duration is either six months or one year.

5. The video game apparatus of claim 1, further comprising game controllers that are slideably mounted to the enclosure.

6. The video game apparatus of claim 5, further comprising a movement detection apparatus, mounted on the enclosure and communicating with the computer processor, the movement detection apparatus enabling control of the home video game without use of the game controllers.

7. The video game apparatus of claim 1, further comprising a power supply located within the enclosure that provides power to the home video game.

8. A method of enabling a public use of a private video game system, the method comprising the steps of:
providing the private video game system in a public environment;
providing a temporary license to the private video game system, the temporary license enabling play of the private video game system in a public environment; and
remotely monitoring the private video game system to ensure compliance with the temporary license.

9. The method of claim 8, where the temporary license has a specific duration.

10. The method of claim 9, where the license duration is either six months or one year.

11. The method of claim 8, further comprising the step of establishing a time period of play of the private video game system based on a received amount of currency.

12. The method of claim 8, further comprising the step of establishing a time period of play of the private video game system based on a number of players.

13. The method of claim 8, further comprising the step of decreasing a time period of play of the private video game system based on a number of players.

14. The method of claim 13, where the time period decreases when the private video game system determines two players are playing.

15. The method of claim 8, further comprising the step of establishing a geographic territory for the temporary license.

16. The method of claim 8, further comprising the steps of:
remotely determining a geographic location of the private video game system; and
determining if the private video game system has a license to operate in the determined geographic area.

17. The method of claim 16, further comprising the step of shutting down the private video game system if the location of the private video game system does not correspond to the geographic area license.

18. A video game apparatus, comprising:
an enclosure comprising a monitor and at least one speaker;
a home video game located in the enclosure;
two game controllers slideably mounted to the enclosure;
a computer processor located within the enclosure and communicating with the home video game, the processor enabling a charge-by-time play of the home video game;
a movement detection apparatus, mounted on the enclosure and communicating with the computer processor, the movement detection apparatus enabling control of the home video game without use of the game controllers; and
a remote management apparatus, located remotely from, and communicating with the computer processor, the remote management apparatus enabling operation of the video game apparatus for a specified time period.

19. The video game apparatus of claim 18, where the charge-by-time play establishes a specific time period for a player to play the home video game.

20. The video game apparatus of claim 18, where the remote management apparatus enables operation of the video game apparatus by obtaining a license having a specific duration.
